(19) United States
(12) Patent Application Publication
(10) Pub. No.: US 2013/0280475 A1
(43) Pub. Date: Oct. 24, 2013

(54) MULTI-LAYER NON-SKID CUSHION PAD FOR DECK WITH EASY REMOVABILITY

(71) Applicant: Charles Ross CHAMPION, Del Mar, CA (US)

(72) Inventor: Charles Ross CHAMPION, Del Mar, CA (US)

(73) Assignee: SOFT-DECK, INC.

(21) Appl. No.: 13/452,421

(22) Filed: Apr. 20, 2012

(51) Int. Cl. B32B 3/06; B23P 17/04; B32B 7/02

(52) U.S. Cl. 428/100; 428/99; 29/428

(57) ABSTRACT

An assembly includes a top cushion layer made of first EVA material defining a flat top surface formed with a non-skid pattern and a bottom surface opposite to the top surface. Also included is a resilient middle cushion layer made of second EVA material softer than the first EVA material. The middle cushion layer defines a top surface supporting the bottom surface of the top cushion layer and a bottom surface opposite to the top surface of the middle cushion layer. The assembly includes a bottom cushion layer made of EVA material and defining a top surface supporting the bottom surface of the middle cushion layer and a bottom surface opposite to the top surface of the bottom cushion layer. The bottom surface of the bottom cushion layer includes at least one fastener configured to removably engage and disengage a complementarily configured fastener substrate on a deck by hand.

### FIELD OF THE INVENTION

The present application relates generally to multi-layer non-skid cushioned pads for ship decks, aircraft decks, industrial machinery decks, and the like that can be easily removed from the deck for various purposes including cleaning, quick access to hatch and hull panels that might be covered by the pads, quick and easy replacement of worn out pads, and rapid conversion of the platform for mission specific tasks.

### BACKGROUND OF THE INVENTION

Present principles recognize that it is desirable to have a cushioning structure that can be applied over an existing deck of a marine vessel as well as other surfaces to reduce shock and impact on both humans and objects on the deck caused by, e.g., impacts transferred through the vessel due to movement of the vessel between high and low points of waves. It is also desirable that the structure be skid-resistant so that individuals and objects do not slide or become otherwise unstable on the deck of a vessel due to movements of the vessel.

Moreover, present principles also recognize that while it is desirable to mitigate shock, impact, etc., by securing a shock-mitigating structure to the surface of a vessel, securing such a structure to the deck of a vessel such that it cannot be easily removed makes it difficult to clean the underlying deck or between adjacent pads, as well as complicate platform conversion, access to hatches and hull panels, and replacement of worn out pads.

### SUMMARY OF THE INVENTION

The present application presents an assembly in one embodiment, wherein the assembly includes a top cushion layer made of first ethylene vinyl acetate (EVA) material defining a flat top surface formed with a non-skid pattern to promote good footing thereon. The top cushion layer also defines a bottom surface opposite to the top surface. The assembly further includes a resilient middle cushion layer made of second EVA material softer (measured by Durometer) than the first EVA material of which the top cushion layer is made. The middle cushion layer defines a top surface supporting the bottom surface of the top cushion layer and a bottom surface opposite to the top surface of the middle cushion layer. Additionally, the assembly includes a bottom cushion layer made of EVA material and defining a top surface supporting the bottom surface of the middle cushion layer. The bottom cushion layer also defines a bottom surface opposite to the top surface of the bottom cushion layer. It is to be understood that the middle cushion layer is softer than both the top and bottom cushion layers.

In addition to the foregoing, the assembly further includes at least one fastener pad on the bottom surface of the bottom cushion layer that is configured to removably engage a complementarily configured fastener substrate on a deck such that the assembly is engageable with the deck by hand by placing the fastener pad on the bottom surface of the bottom cushion onto the fastener substrate on the deck. The assembly is also disengageable with the deck by hand by lifting the assembly to lift the fastener pad on the bottom surface of the bottom cushion away from the fastener substrate on the deck.

If desired, the top, middle, and bottom cushion layers may be laminated together. Also if desired, the top and bottom cushion layers may have the same density, but the top cushion layer may still be thinner than the middle cushion layer. Furthermore, in some embodiments, the top surface of the top cushion layer may be tacky or have any other surface appreciated by those skilled in the art to create friction between the top surface of the top cushion layer and a person standing thereon.

In some embodiments the assembly may also include four elongated hook or eye fastener pads on the bottom surface of the bottom cushion layer. Each pad may be parallel along its axis of elongation to a respective edge of the bottom cushion layer. However, in some embodiments the pad may be perpendicular to the axis of elongation or may be at arranged at any other angle, it being understood that in some embodiments a combination of differently angled arrangements of the pads may be used. Additionally, in some embodiments the top surface of the top cushion layer may be resistant to ultraviolet (UV) radiation, while at least the top cushion layer and up to all three cushion layers may be waterproof and/or water-resistant, fire retardant and/or fire resistant, and may also be resistant to ultraviolet (UV) radiation in exemplary embodiments.

In another aspect, a deck cover assembly includes a multi-ply resilient body disposable on a deck to cover the deck and provide cushioning comfort to a person walking on the resilient body. This reduces fatigue by reducing vibrations and impacts transmitted through the deck to crew and cargo. The deck cover assembly also includes at least one cushion adhesion element on a bottom surface of the resilient body facing the deck to engage a complementary deck adhesion element disposed on the deck when the resilient body is placed onto the deck. It is to be understood that the adhesion elements are disengaged from each other by lifting the resilient body by hand off of the deck. Thus, the adhesion elements are fully engaged with each other solely by placing the cushion adhesion element onto the deck adhesion element and pressing down, and are fully disengaged with each other solely by lifting the resilient body by hand off of the deck.

In yet another aspect, a method includes assembling at least two cushion layers together to define a pad. The pad establishes at least a flat top surface and a flat bottom surface opposite to the top surface. The method also includes securely applying at least one fastener element to the bottom surface of the pad. The method then includes engaging the fastener element on the bottom surface of the pad with a complementary fastener element on a top surface of a vehicle or vessel such that the pad is engageable and disengageable with the top surface of a vehicle or vessel by hand. It is to be understood that the top surface of the vehicle or vessel defines an area suitable for people to stand and/or sit on.

The details of current embodiments, both as to structure and parts, can best be understood in reference to the accompanying figures, in which like figures refer to like parts, and in which:

### BRIEF DESCRIPTION OF THE DRAWINGS

FIG. 1 is a perspective view showing one example environment in which a deck cover may be utilized in accordance with present principles, it being understood that present principles apply to other environments as well;

FIG. 2 is an exploded perspective view of a deck cover in accordance with present principles and showing a non-slip pattern on a top surface of a top cushion of the cover and also showing a complementary hook/eye fastener substrate on a deck;

FIG. 3 is a side elevational view of an exemplary embodiment of a deck cover in accordance with present principles; and

FIG. 4 is an exploded perspective view of the bottom surface of a bottom cushion layer of an exemplary embodiment of a deck cover in accordance with present principles showing the bottom surface of the bottom cushion layer of a deck cover and including four fastener pads removably engageable with complementarily configured fastener substrates on a deck.

### DETAILED DESCRIPTION OF THE PREFERRED EMBODIMENT

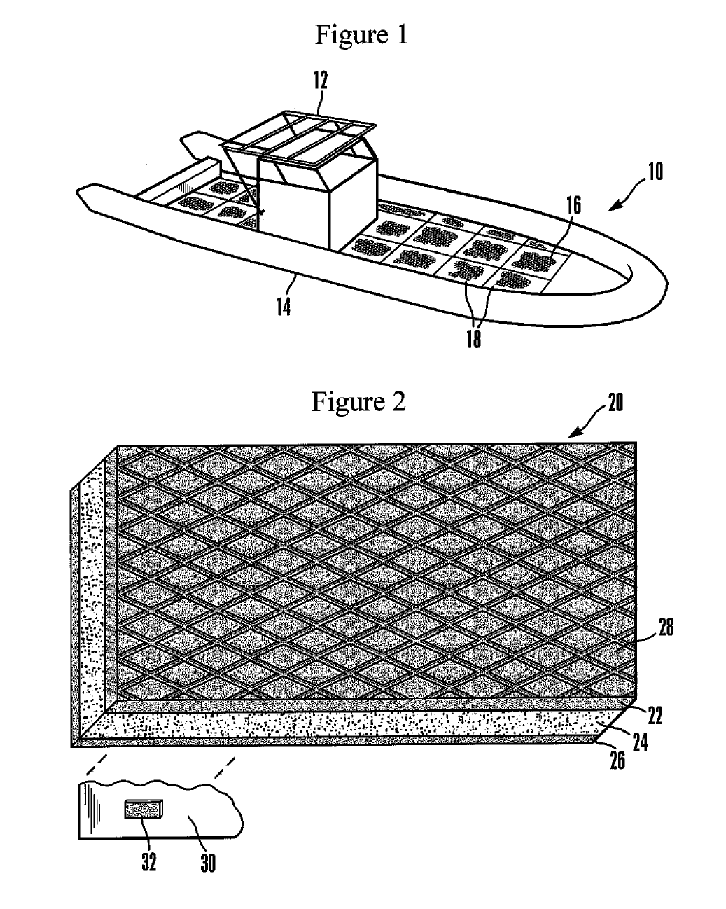

Initially referring to FIG. 1, a perspective view of an example environment in which a deck cover may be utilized in accordance with present principles is shown. However, note that while FIG. 1 shows a deck cover disposed in a rigid inflatable boat, it is to be understood that present principles apply to other marine environments such as larger boats (e.g., house boats, naval vessels, cargo ships, oil tankers, etc.) and still other moving and/or motorized vehicles such as commercial trucks. Present principles may have still other applications, such as space equipment/shuttles, buildings, construction, manufacturing environments such as industrial machinery decks, aeronautical environments such as aircraft decks, etc.

Regardless, it may be appreciated from FIG. 1 that a small boat 10 is shown. The boat 10 may have a navigation area/control area 12, inflatable portions 14, and a deck 16. FIG. 1 also shows an exemplary deck cover 18 providing cushioning comfort to a person walking or standing thereon, the deck cover 18 as shown in FIG. 1 having individual sections or pads, described further below, applied in a grid-pattern on the deck 16. It is to be understood that other portions of the boat 10 are not shown for clarity, such as, e.g., a motor and/or sail, railings, tie-down areas, on-board compartments, etc. It is to be further understood that the deck cover 18 may cover the entire deck, or only part of the deck as desired (such as only covering exposed areas not having equipment or other structures placed thereon).

Turning now to FIG. 2, an exploded perspective view of a deck cover segment or pad 20 in accordance with present principles is shown. FIG. 2 also shows a complementary hook/eye fastener substrate 32 on a deck 30 with which the pad 20 is engaged according to description below.

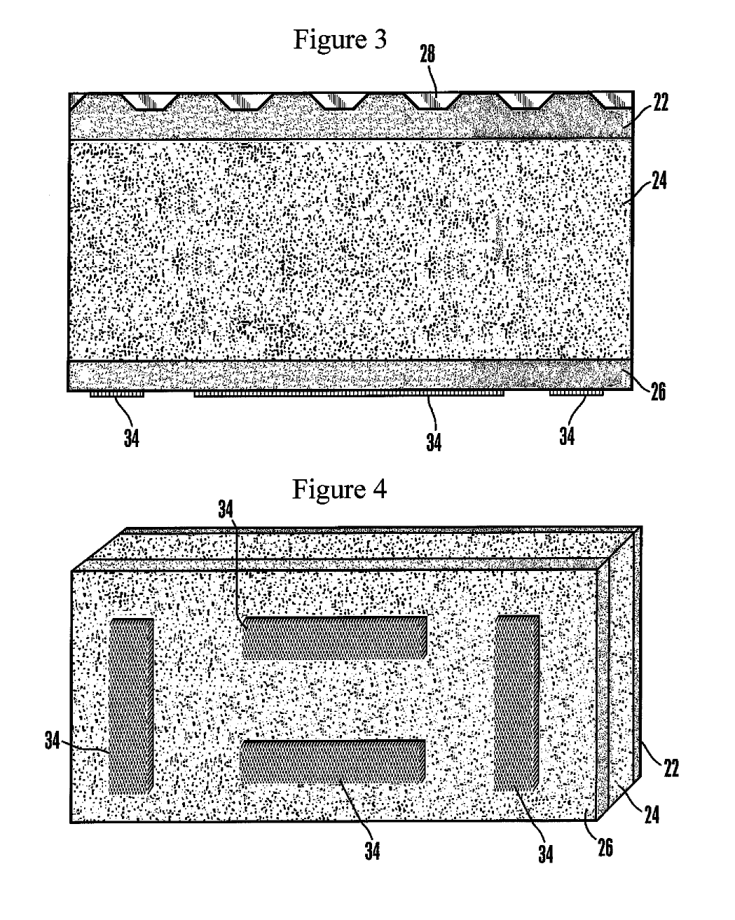

As shown in cross-reference to FIGS. 2 and 3, the three-ply deck cover 20 has a top cushion layer 22, middle cushion layer 24, and bottom cushion layer 26. In some embodiments, the layers 22, 24, and 26 may be laminated flush together using, e.g., a suitable cement or adhesive, though other methods appreciated by those within the art may be used to join and/or assemble the layers 22, 24, 26 together to establish the deck cover 20.

Furthermore, it is to be understood that the layers may be made of a foam such as, but not limited to, ethylene vinyl acetate (EVA) material, or a combination of EVA and other cushioning material known in the art such as, but not limited to, rubber such as closed-cell rubber. Note that the EVA may also exhibit closed-cell properties, thereby preventing the closed-cell EVA and/or rubber from absorbing water. Thus, in some embodiments the top cushion layer 22 may be made of a high-density EVA material defining a relatively and/or at least partially flat top surface formed with a non-skid pattern/traction pattern 28 to promote good footing thereon. It may be appreciated from FIG. 2 that the top cushion layer 22 further defines a bottom surface opposite to the top surface of the top cushion layer 22.

Further addressing the disclosed EVA material, it is to be understood that the material may be comprised of the copolymer of ethylene and vinyl acetate. The weight percent vinyl acetate may vary from ten percent to forty percent, with the remainder being ethylene in exemplary embodiments. EVA material may be a thermoplastic polymer that approaches elastomeric materials in softness and flexibility, yet can be processed like other thermoplastics. Advantages of EVA material include good clarity and gloss, barrier properties, low-temperature toughness, stress-crack resistance, hot-melt adhesive waterproof or water resistant properties, and resistance to UV radiation. Additionally, the EVA preferably has little or no odor. In some embodiments, the EVA material may also be fire retardant and/or fire resistant by virtue of its composition, e.g., by being impregnated with file retardant material, or alternatively the deck cover 20 may have a fire retardant/fire resistant coating applied to the surface of, e.g., the top surface of the top cushion layer 22 to facilitate fire resistance.

Describing the non-skid pattern 28 in more detail, present principles recognize that the pattern 28 promotes good footing and/or promotes friction between a person or object and the deck cover. Accordingly, the pattern 28 may be the diamond pattern shown. However, other patterns and/or configurations may be used such as, but not limited to, lines, line segments, and wave-patterns. Still other geometric patterns may be used, such as circles, ellipses, other radial patterns, rectangles, triangles, one or a combination of different polygons, sinusoidal patterns, hyperbolic patterns, parabolic patterns, spiral/helical patterns, and other algebraic curves, transcendental curves, derived curves, and/or grooves. Additionally, dots and/or sandpaper-type surfaces may be used in lieu of or in addition to the patterns described above. If desired, the top surface of the top cushion layer 22 may be tacky (or have any other surface appreciated by those skilled in the art to create friction between the top surface of the top cushion layer 22 and a person standing thereon) instead of having any of the configurations listed above, or the top surface having any of the configurations listed above may nonetheless be tacky in addition to having pattern. However, note that the recitation of patterns discussed herein is not meant to be exhaustive such that still other mathematical curves/patterns/shapes may be used.

Furthermore, it is to be understood that the configurations listed above may be cut, carved, embossed, heavily brushed, sanded, molded, and/or embedded into the top surface of the top cushion layer 22 to establish a desired pattern, it being understood other methods known within the art may be used as well. Moreover, the patterns may be inlaid, recessed into on the top surface of the top cushion layer 22, or may protrude upwardly from the top surface of the top cushion layer 22.

Still in reference to FIGS. 2 and 3, the resilient middle cushion layer 24 shown may be made of second EVA material having a greater elasticity and being relatively softer than the first EVA material of which the top cushion layer is made is shown. Note that the middle cushion layer 24 defines a top surface supporting the bottom surface of the top cushion layer 22 and defines a bottom surface opposite to the top surface of the middle cushion layer 24. Additionally, the bottom cushion layer 26 may be made of EVA material and define a top surface supporting the bottom surface of the middle cushion layer 24. The bottom cushion layer 26 also defines a bottom surface opposite to the top surface of the bottom cushion layer 26.

Thus, it is to be understood that in some embodiments, the middle cushion layer 24 is softer than both the top cushion layer 22 and bottom cushion layer 26, thereby contributing relatively more to impact mitigation than the layers 22 and 26, it being nonetheless understood that the top and bottom cushion layers 22 and 26 may also contribute to impact mitigation. Also in some embodiments, the top cushion layer 22 and bottom cushion layer 26 may have the same density and/or durometer, though they may vary in density and durometer from each other and from the middle cushion layer 24 if desired. In other embodiments, all three of the layers 22, 24, and 26 may have the same density and/or softness.

Also note that as best shown in FIG. 3, the thickness of each of the layers 22, 24, and 26 may vary. Thus, in one embodiment, the top cushion layer 22 may be relatively thinner than the middle cushion layer 24, as may be appreciated from FIG. 2. Additionally, if desired, the top cushion layer 22 may have the same thickness as the bottom cushion layer 26, though in other embodiments the thickness of the layers 22 and 26 may be different from each other. Regardless, it is to be understood that all three of the layers 22, 24, and 26 may compress under impact by a person or object, yet return to their respective pre-impact shape after the force from the impact has been disbursed. However, note that in embodiments where the top and bottom cushion layers 22 and 26 are made of a relatively more dense material (e.g., EVA foam) than the middle cushion layer 24, the layers 22 and 26 may be more resistant to compression than the middle cushion layer 24.

Accordingly, in some embodiments the top and bottom cushion layers 22 and 26 may be similar in configuration save for the fact that the bottom cushion layer 26 may not include a similar non-skid pattern as the non-skid pattern 28. Accordingly, while the top and bottom cushion layers 22 and 26 may generally be comprised of a relatively more dense material and may even have the same density, thickness, and/or softness, the bottom cushion layer 26 may be relatively more flat on its top than the top surface of the top cushion layer 22.

FIG. 2 also shows the above-mentioned portion of an exemplary deck 30 having a complementary hook or eye fastener element or substrate 32 such that the deck cover 20 may be removably engaged with the deck 30. To this end and cross-referencing FIGS. 2 and 4, the bottom surface of the bottom cushion layer 26 facing the deck 30 has one or more hook or eye fastener elements 34 to engage respective hook or eye fastener elements or substrates 32 on the deck 30 by hand. In exemplary embodiments, four elongated hook or eye fastener elements on the bottom surface of the bottom cushion layer 26 may engage the complementary hook or eye fastener elements on the deck 30, though more or less than four hook or eye fastener element sets may be used to engage the deck 30 with the deck cover 20. Also in some embodiments, each hook or eye fastener element may be parallel along its axis of elongation to a respective edge of the bottom cushion layer 26 as best shown in FIG. 4. However, it is to be understood that the pad may be perpendicular to the axis of elongation of a respective edge, or may be at arranged at any other angle. Furthermore, in some embodiments a combination of differently angled arrangements of the hook or eye fastener element sets may be used.

While hook/eye fastener elements have been described in reference to some of the non-limiting embodiments above, and “hook and eye” typically refers to the material known as “Velcro” (trademark) in which hard plastic eyes engage flaccid thread-like hooks, it is to be understood that “hook and eye” as referred to herein also includes releasable fasteners with both pieces being established by relatively hard plastic loops. The dual lock low profile reclosable fasteners manufactured by 3M Company are an example of such releasable fastener structure.

With greater specificity relating to the dual lock low profile reclosable fasteners mentioned in the preceding paragraph, two complementary lock fasteners can be engaged with each other, e.g., by being pressed together with light to moderate force or by placing the cushion adhesion element onto the deck adhesion element. When this occurs, stems on one of the fastener elements which extend perpendicularly away from the plane of a substrate defining one end of the stems engage similarly configured stems on a complementary substrate to form a secure attachment.

As yet another alternative to hook and eye fasteners, one or both of the releasable engagement pads of a pair, also referred to herein as “adhesion elements”, may include a relatively weak adhesive such that the pad securely but releasably attaches to a decking or surface, which may also include the adhesive if desired.

In any case, it may now be appreciated that the deck cover 20 may be disengaged by hand solely by lifting the deck cover 20 to lift the fastener pads 34 on the bottom surface of the bottom cushion layer 26 away from complementary fastener pads/substrates 32 on the deck 30 while the respective substrates nonetheless remain engaged with their respective surfaces (the deck or the bottom surface of the bottom cushion layer 26) by virtue of the adhesive or other attaching means.

In some embodiments, the engagement or disengagement of the stems extending away from one surface of respective substrate (thus defining one complementary surface) with stems extending away from the other substrate (thus defining the other complementary surface) may even create an audible sound such as a “click” or “snap.” Also note that in some embodiments, the stems may be mushroom-shaped to facilitate the engagement described above. However, notwithstanding the foregoing description of dual lock fasteners, Velcro or other engagement pads and engagement means appreciated by those within the art may be used in lieu of, or in conjunction with, the dual lock fasteners and/or the hook/eye fasteners. For example, double-sided tape and reusable adhesive fasteners may be used as adhesion elements. Note that in still other embodiments, a combination of only hook/eye fasteners and dual lock fasteners may be used.

In light of all of the foregoing, it may be appreciated that a method in accordance with present principles may include assembling at least two cushion layers together to define a pad such that the pad establishes at least a flat top surface and a flat bottom surface opposite to the top surface. The method also includes securely applying at least one fastener element to the bottom surface of the pad and engaging the fastener element on the bottom surface of the pad with a complementary fastener element on a top surface of a vehicle or vessel. The pad is thus engageable and disengageable with the top surface of a vehicle or vessel by hand. It is to be understood that the top surface of the vehicle or vessel defines an area which is suitable for people to stand and/or sit. Other methods may be employed in accordance with present principles, such as methods of shaping a deck cover to conform to the shape and/or contours of a deck (e.g., by cutting or forming the deck cover itself into sections and/or particular shapes), as well as configuring the fastener elements described above on the bottom surface of a bottom cushion layer of the deck.

It may now be appreciated that present principles employ shock (vibration) and impact mitigation in, e.g., a marine environment when force is translated/transferred through the structure of the marine vessel to mitigate the impact felt by the crew or cargo standing/placed thereon. In other words, an impact by a person or object at a certain focal point on the top layer of the deck cover is transmitted to the surrounding material of the deck cover. The impact is not only cushioned directly under the body but is also transmitted and disbursed to the surrounding area of the deck cover. It may also be appreciated that the impact made by a person or object on the deck itself is cushioned.

The deck cover embodiments disclosed herein also provide a slip and/or skid resistant surface to enhance traction in both wet and dry conditions while providing a structural wear resistant surface by way of the configuration of the bottom cushion layers disclosed herein, the bottom cushion layers also providing a solid, secure, and resilient mounting surface for the fasteners disclosed herein. The bottom cushion layer also provides structure and/or foundation for the remainder of the deck cover. Last, note that the deck covers disclosed herein may be installed over an existing deck surface.

With the above in mind, the present removable deck pads are used for shock and impact mitigation, vibration and noise dampening for crew or cargo, fatigue reduction, providing a non-skid surface in wet and moving environments, provide a soft high friction/traction surface, and provide cushioning and padding. As will be appreciated from the above, the present pad accomplishes the above through the described composition of the material. The pad is soft yet stable to stand on and is resilient in its ability to return to its original shape after momentary or prolonged impacts. The pad is very lightweight, on the order of 12.8 ounces per square foot, and has an aggressive traction surface that will not tear skin, but will protect people and cargo in the event of a fall. The pad is easily removable by hand and can be easily shaped during manufacture. Preferably the pad is water proof and when made as described has positive buoyancy, so that if it is dropped overboard during installation it is easily retrievable. The pads can be applied to any surface where padding is needed, not only deck or surfaces people can sit/stand/walk on. For example, the pads may be applied to walls and ceilings.

Among non-limiting benefits of the description above are shock mitigation to reduce injury to crew and damage to cargo as a result of a severe impact or repetitive minor impacts. Crew fatigue is reduced by reducing vibrations transmitted from the craft to the crew and or cargo. Among the benefits of cushioning are the reduction of injury in the event of a fall or in to or on a surface covered with the product. Among the benefits of the soft nonskid material of the pad are high friction yet soft surface providing exceptional traction wet or dry with or without shoes, and not tearing clothes or skin as a grip tape or similar traction promoter can do. Among the benefit of being resilient is that the pad does not break down even after years of multiple impacts, and will return to its original shape after all but the most sever prolonged compressions. Among the benefits of being light weight is easy handling and mounting without significantly affecting the gross weight of the platform to which it is being applied.

Among the benefits of being removable are that easy removability allows the product to be installed over the entire decking surface yet still retain the ability to access hatches and access panels below the product. The ease of removability also provides for quick and easy mission specific customization, e.g., fore deck pieces can be removed quickly to facilitate the installation of removable seats, a crane, etc. This need is very common on smaller craft such as rigid inflatable boats. The ease of removability also allows for quick and easy replacement of the product, in addition to being able to remove the pads for cleaning.

By being easily shaped during manufacture, the pads can be molded to fit different deck or platform contours.

What is claimed is:

1. Assembly comprising:
a top cushion layer made of first ethylene vinyl acetate (EVA) material defining a flat top surface formed with a non-skid pattern to promote good footing thereon, the top cushion layer defining a bottom surface opposite to the top surface;
a resilient middle cushion layer made of second EVA material softer than the first EVA material of which the top cushion layer is made, the middle cushion layer defining a top surface supporting the bottom surface of the top cushion layer, the middle cushion layer defining a bottom surface opposite to the top surface of the middle cushion layer;
a bottom cushion layer made of EVA material and defining a top surface supporting the bottom surface of the middle cushion layer, the bottom cushion layer defining a bottom surface opposite to the top surface of the bottom cushion layer, the middle cushion layer being softer than both the top and bottom cushion layers; and
at least one fastener pad on the bottom surface of the bottom cushion layer and configured to removably engage a complementarily configured fastener substrate on a deck such that the assembly is engageable with the deck by hand by placing the fastener pad on the bottom surface of the bottom cushion onto the fastener substrate on the deck, the assembly being disengageable with the deck by hand by lifting the assembly to lift the fastener pad on the bottom surface of the bottom cushion away from the fastener substrate on the deck.

2. The assembly of claim 1, wherein the layers are laminated together.

3. The assembly of claim 1, comprising four elongated hook or eye fastener pads on the bottom surface of the bottom cushion layer, each pad being parallel along its axis of elongation to a respective edge of the bottom cushion layer.

4. The assembly of claim 1, wherein the top and bottom cushion layers have the same density.

5. The assembly of claim 1, wherein the top surface of the top cushion layer is tacky.

6. The assembly of claim 1, wherein the top surface of the top cushion layer is resistant to ultraviolet (UV) radiation.

7. The assembly of claim 1, wherein the top cushion layer is thinner than the middle cushion layer.

8. The assembly of claim 1, wherein the layers are waterproof.

9. Deck cover assembly comprising:
multi-ply resilient body disposable on a deck to cover the deck and provide vibration and shock mitigation to a person walking on the resilient body; and
at least one cushion adhesion element on a bottom surface of the resilient body facing the deck to engage a complementary deck adhesion element disposed on the deck when the resilient body is placed onto the deck, the adhesion elements being disengaged from each other by lifting the resilient body by hand off of the deck, the adhesion elements being fully engaged with each other solely by placing the cushion adhesion element onto the deck adhesion element and pressing down on the cushion adhesion element, the adhesion elements being fully disengaged with each other solely by lifting the resilient body by hand off of the deck.

10. The assembly of claim 9, wherein the resilient body comprises three cushion layers laminated together, at least two of the three cushion layers have durometers different from each other.

11. The assembly of claim 9, further comprising four elongated hook or eye fastener pads on the bottom surface of the resilient body facing the deck, each pad being parallel along its axis of elongation to a respective edge of the resilient body.

12. The assembly of claim 10, wherein top and bottom cushion layers of the resilient body have the same density, the top cushion layer defining a flat top surface of the resilient member and defining a bottom surface opposite to the top surface, the bottom cushion layer defining a top surface supporting the bottom surface of a middle cushion layer and defining a bottom surface opposite to the top surface of the bottom cushion layer, the middle cushion layer defining a top surface supporting the bottom surface of the top cushion layer and defining a bottom surface opposite to the top surface of the middle cushion layer.

13. The assembly of claim 12, wherein the top surface of the top cushion layer is tacky.

14. The assembly of claim 9, wherein resilient body is resistant to ultraviolet (UV) radiation and/or waterproof.

15. The assembly of claim 12, wherein the top cushion layer is thinner than the middle cushion layer.

16. The assembly of claim 9, further comprising the deck.

17. Method, comprising:
assembling at least two cushion layers together to define a pad, the pad establishing at least a flat top surface and a flat bottom surface opposite to the top surface;
securely applying at least one fastener element to the bottom surface of the pad; and
engaging the at least one fastener element on the bottom surface of the pad with a complementary fastener element on a top surface of a vehicle or vessel solely by placing the pad on top of the top surface of the vehicle or vessel such that the pad is engageable and disengageable with the top surface of a vehicle or vessel by hand, the top surface of the vehicle or vessel defining an area which is suitable for people to stand and/or sit.

18. The method of claim 17, wherein three cushion layers are assembled together to define a 3-ply pad.

19. The method of claim 17, wherein the top surface of a vehicle or vessel is the deck of a marine vessel.

20. The method of claim 17, wherein the act of assembling includes laminating the at least two cushion layers together.
